(19) United States
(12) Patent Application Publication
(10) Pub. No.: US 2001/0045139 A1
(43) Pub. Date: Nov. 29, 2001

(54) Apparatus and method for producing a pinion assembly

(76) Inventor: Graham A. Fullerton, Canton, MI (US)

Correspondence Address: MCKENNA & CUNEO, LLP, 1900 K Street, NW, Washington, DC, 20006, US

(21) Appl. No.: 09/832,903

(22) Filed: Apr. 12, 2001

Related U.S. Application Data
(60) Provisional application No. 60/197,399, filed on Apr. 14, 2000.

(51) Int. Cl. F16H 1/14

(52) U.S. Cl. 74/424

(57) ABSTRACT

The present invention relates to a system and apparatus used in conjunction with drive mechanisms in vehicles for efficient energy transfer through a pinion assembly and associated bearings to the wheels of a vehicle. The apparatus includes various types of fasteners, a drive flange, pinion shaft, and an integrated bearing assembly.

### CROSS REFERENCE TO RELATED APPLICATIONS

The present application is related to and claims the benefit of, under 35 U.S.C. § 119(e), U.S. Provisional Patent Application Serial No. 60/197,399, filed Apr. 14, 2000, which is expressly incorporated fully herein by reference.

### BACKGROUND OF THE INVENTION

1. Field of the Invention

The present invention relates to an apparatus and method used in conjunction with drive mechanisms in vehicles for efficient energy transfer through a pinion assembly and associated components, including bearings, to the wheels of a vehicle.

2. Description of the Prior Art

FIG. 1 illustrates a configuration of a typical axle differential pinion assembly. One end of the pinion connects to a drive shaft, which is connected to a motor and a transmission, which transmits torque. The opposite end of the pinion connects to a differential that transfers power to the wheels of the vehicle.

Referring again to FIG. 1, tightening threaded fastener 180 against counterbore 193 of drive flange 190 transmits force through pinion shaft 100 to first and second bearings 200 and 210, creating bearing preload. Bearing preload creates stiffness and affects the life of the bearing. Stiffness within the pinion shaft prevents vertical and axial movement of the shaft, which improves torque transmission efficiency and reduces noise. A light preload reduces the stiffness and creates noise within the bearing, reducing the life of the bearing. Conversely, a heavy preload also causes failure. Thus, the ability to control bearing preload precisely allows bearing manufacturers to control and predict the life of the bearing.

The manner in which the bearing sits on the pinion shaft affects the efficiency of the configuration. Referring again to FIG. 1, bearings 200 and 210 are spaced apart along the pinion shaft. A wide bearing spread 205 prevents deflection of pinion shaft 100 and thus, creates stiffness. Wide bearing spread, however, necessitates machining bearing seats 145 and 155 separately (double machining). Double machining creates inaccuracies, which may cause misalignment. This potential misalignment may cause premature bearing failure. Also, because the assembly of the pinion and associated components controls the amount of preload, assembly directly affects the life of the bearing and thus the efficiency of the pinion assembly. Double machining also increases the cost of manufacture. The present invention attempts to solve these problems and provide a pinion assembly design that increases the efficiency of torque transmission, facilitates quick and accurate assembly and service, and controls bearing preload.

### SUMMARY OF THE INVENTION

The basic purpose of an axle differential is to transfer torque from the engine through a drive shaft to the wheels. Less than eighteen percent of the energy generated from fuel in an automobile reaches the wheels of the automobile in the form of torque. Therefore, one of the objects of the invention is to provide a system and apparatus that creates a more efficient torque transfer system.

Other advantages of the present invention include, for example, increasing system strength, reducing system size, increasing pinion shaft stiffness, reducing bearing noise, reducing bearing misalignment, facilitating accurate manufacture, facilitating quick and accurate assembly and service, and controlling bearing preload.

One object of the present invention is to provide a pinion assembly having an integral (i.e., single unit or unitary) bearing assembly in place of a plurality of bearing assemblies. Another object of the present invention is to provide a pinion assembly with formable or threaded fasteners. Yet another object of the present invention is to control preload of the bearing and stiffness of a pinion assembly. Another object of the present invention is to increase the stiffness of a pinion assembly. Still another object of the present invention is to decrease the assembly time of a pinion assembly. Another object of the present invention is to decrease the manufacture time of a pinion assembly.

In one embodiment of the present invention, the apparatus for the pinion assembly may comprise a pinion shaft of varying diameters having a first and second end, wherein said first end may be adapted to fasten to a drive assembly; a roll-over fastener or a threaded fastener formed on the first end of the pinion shaft; a drive flange that may be connected to the first end of the pinion shaft by either a roll-over or threaded faster; and an integral bearing assembly. The integral bearing assembly may have a first and second end that may facilitate rotation between the pinion shaft and the integral bearing assembly. The integral bearing assembly may contain one or more rolling elements that each have an inner and outer race.

In one embodiment of the present invention, the first end of the pinion assembly may abut the drive flange. In another embodiment of the present invention, the integral bearing assembly may have two rolling element bearings. In yet another embodiment of the present invention, the inner race of the second rolling element bearing may be formed into the second end of the pinion shaft.

In one embodiment of the present invention, bearing preload may be controlled by the apparatus described above and by positioning an inner race on a pinion shaft and providing a roll-over fastener to attach a pinion assembly to a drive flange. In one embodiment of the present invention, the integral bearing assembly may contain two bearings. In another embodiment of the present invention, the inner race of a second bearing may be ground into the second end of a pinion shaft.

In an embodiment of the present invention, increased stiffness of the pinion assembly may be achieved by positioning an inner race on a pinion shaft and optimizing the distance between a pressure point and load lines and redistributing the forces along a pinion shaft. In other embodiments of the present invention, the fastener may be either a roll-over fastener or a threaded fastener. In another embodiment of the present invention, stiffness may be created by positioning the bearings of the pinion assembly closer to a pinion gear.

In one embodiment of the present invention, assembly time for the pinion assembly apparatus may be decreased by controlling bearing flange to pinion gear distance. In another embodiment, assembly time may be decreased by integrating the bearing units. In yet another embodiment of the present invention, manufacture time of the pinion assembly may be decreased by minimizing the number of areas to be formed on the pinion apparatus. In another embodiment, manufacture time may be decreased by placing the inner race of a bearing assembly on the pinion shaft of the pinion apparatus. In still another embodiment of the present invention, minimizing the number of areas to be formed in the pinion apparatus may be achieved by forming one bearing seat. In another embodiment of the present invention, forming the bearing seat may be achieved by either forging, grinding, or machining the bearing seat. In yet another embodiment of the present invention, the inner race of the bearing closest to the end of the pinion shaft may be formed on the pinion shaft.

Other objectives, features and advantages of the present invention will become apparent from the following detailed description. The detailed description and the specific examples, while indicating specific embodiments of the invention, are provided by way of illustration only. Accordingly, the present invention also includes those various changes and modifications within the spirit and scope of the invention that may become apparent to those skilled in the art from this detailed description.

It is to be understood that both the foregoing general description and the following detailed description are exemplary and explanatory only and are not restrictive of the invention, as claimed.

The accompanying drawings, which are incorporated in and constitute a part of this specification, illustrate several embodiments of the invention and together with the description, serve to explain the principles of the invention.

### BRIEF DESCRIPTION OF THE DRAWINGS

FIG. 1 is a schematic drawing of a typical axle differential pinion assembly.

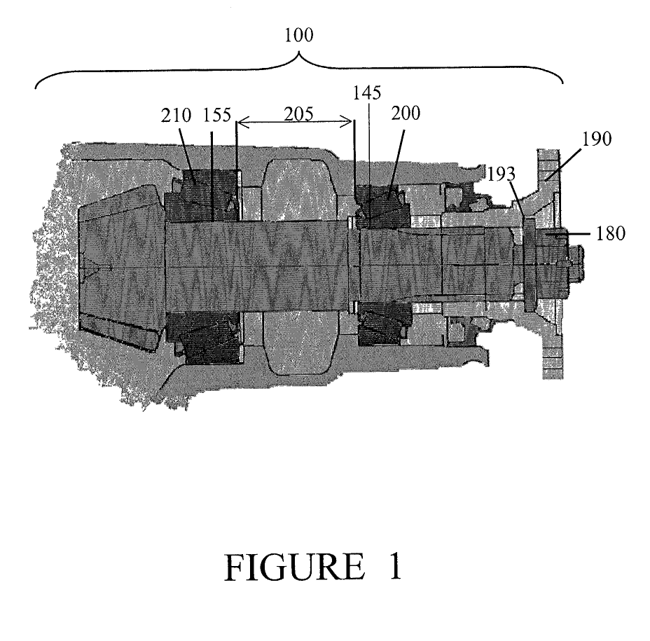

FIG. 2 is a schematic drawing that illustrates the pressure points and loadlines in a pinion assembly.

FIG. 3 is a schematic drawing of a integrated bearing/pinion assembly with a pinion shaft roll-over fastener.

FIG. 4 is a schematic drawing of an alternative embodiment of the present invention with an integrated bearing assembly and a threaded fastener.

FIG. 5 is a schematic drawing of a pinion assembly having the bearing fully integrated using a pinion shaft roll-over fastener.

FIG. 6 is a schematic drawing of a pinion assembly having the bearing fully integrated using a threaded fastener.

### DETAILED DESCRIPTION OF THE PREFERRED EMBODIMENTS

Reference will now be made in detail to the present preferred embodiments and exemplary embodiments of the invention, examples of which are illustrated in the accompanying drawings. It is understood that the terminology used herein is used for the purpose of describing particular embodiments only, and is not intended to limit the scope of the present invention. It must be noted that as used herein and in the appended claims, the singular forms “a,” “an,” and “the” include plural reference unless the context clearly dictates otherwise. Thus, for example, a reference to “shim” is a reference to one or more shims and includes equivalents thereof known to those skilled in the art and so forth.

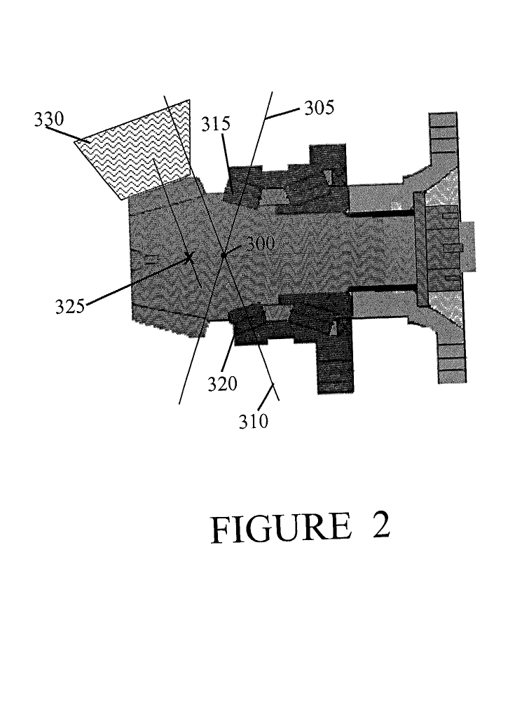

FIG. 2 illustrates the concepts of a pressure point and a load line in a pinion assembly. These two concepts are instrumental in creating pinion stiffness and strength. The pressure point 300 of a pinion is defined as the point at which the two bearing pressure lines (305, 310) intersect within the pinion. Bearing pressure lines 305 and 310 are straight lines that run through the center of rolling elements 315 and 320 and are perpendicular to the rolling elements. Load line 325 is defined as the normal force, or the force that pinion gear 330 exerts upon the end of the pinion, that is directed perpendicular to pinion gear 330 through its center onto the pinion. Placing pressure point 300 closer to load line 325 redistributes the forces along the pinion shaft, increasing the stiffness of the pinion; thus, the distance between pressure point 300 and load line 325 is preferably optimized to increase stiffness.

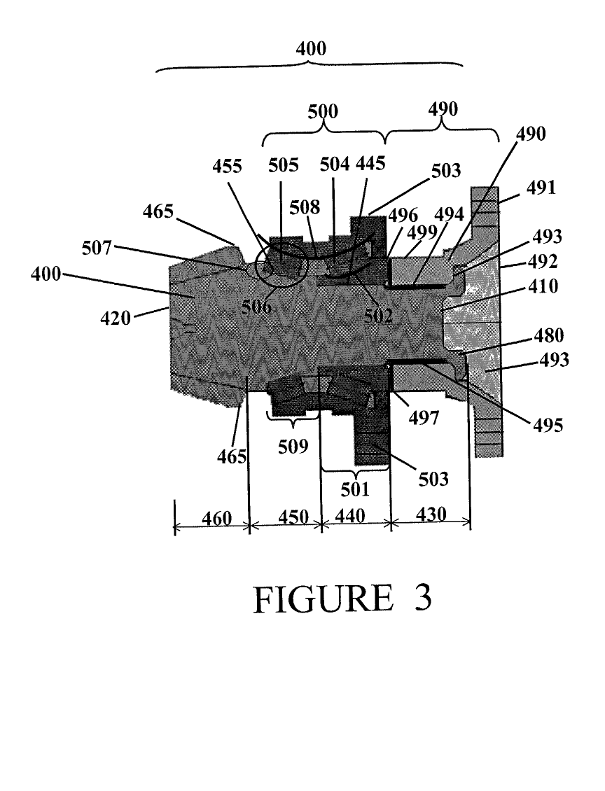

FIG. 3 shows an embodiment of a pinion assembly of the present invention having an integrated bearing unit (i.e., single unit or unitary) and a roll-over fastener. Pinion shaft 400 preferably has two ends 410 and 420 and four substantially cylindrical or tubular (or equivalent shapes) sections 430, 440, 450, and 460. Pinion shaft 400 may be made of any material that is appropriate for withstanding typical loads, fatigue, wear, and stress, such as for example, steel or steel alloys and other materials with similar or related properties.

First end 410 of pinion shaft 400 is preferably made of formable material such that the material may be rolled over an adjoining component for fastening purposes. First section 430 includes first end 410, is preferably substantially or relatively cylindrical or tubular in shape with the exception of the portion of pinion shaft 400 that forms roll-over fastener 480 (although it may be of other equivalent shapes as well), preferably has the smallest shaft diameter of the sections, and extends from first end 410 to second section 440.

Second section 440 is preferably substantially or relatively cylindrical or tubular in shape (although it may be of other equivalent shapes as well), extends from first section 430 to third section 450 and has a diameter preferably greater than first section 430 but preferably smaller than third section 450. The entire diameter of second section 440 may be formed (e.g., ground, machined, or forged) to serve as a integral bearing seat 445. Integral bearing seat 445 is where the integral bearing assembly contacts pinion shaft 400 and is located around the circumference of second section 440 of pinion shaft 400.

Third section 450 of pinion shaft 400 is preferably relatively cylindrical or tubular in shape (although it may be of other equivalent shapes as well), extends from second section 440 to fourth section 460, and preferably has a varying diameter greater than second section 440 but smaller than fourth section 460. Third section 450 preferably has a machined, ground, or forged portion increasingly angled toward fourth section 460 that serves as the inner race 455 for the second bearing 505 in an integral (i.e., single unit or unitary body) bearing assembly 500. Before third section 450 abuts fourth section 460 the diameter is preferably increased and there is a small lip 507. After small lip 507, the diameter of pinion shaft 400 remains relatively constant.

Fourth section 460 is preferably shaped like a modified truncated cone and has varying diameters, all of which are preferably greater than the diameter of third section 450. Fourth section 460 is angled at an increasing angle away from third section 450. The angle is truncated at second end 420 of pinion shaft 400.

First end 410 of pinion shaft 400 is preferably made of formable material that is adapted to be rolled over counterbore 493 in drive flange 490 to serve as a roll-over fastener 480 that holds pinion shaft 400 in proper positioning within drive flange 490. Drive flange 490 is coaxial with pinion shaft 400 and is held in place by roll-over fastener 480.

Drive flange 490 has two ends 491 and 499, is coaxial with pinion shaft 400, and is preferably held in place by roll-over fastener 480 and a spline coupling 495. Drive flange 490 may be made of any material that is appropriate for withstanding typical loads, fatigue, wear and stress, such as for example, steel or steel alloys. First end 491 of drive flange 490 has a large diameter with a concentric concave angled aperture 492. Aperture 492 may extend at a decreasing angle towards the interior end of the aperture and includes counterbore 493. Counterbore 493 is inside the interior end of aperture 492. Counterbore 493 is what roll-over fastener 480 curves into once it is rolled over and is preferably of a larger diameter than the hollow cylindrical section 494 of drive flange 490. Spline coupling 495 of hollow cylindrical section 494 fits concentrically around a portion of first section 430, and may be a typical spline coupling or fitting or any other mechanical equivalent. Hollow cylindrical section 494 of drive flange 490 extends from roll-over fastener 480 to second end 499, which may abut integral bearing assembly 500. Shims 496 and 497 may be placed between second end 499 of drive flange 490 and first span 501 of integral bearing assembly 500.

Integral bearing assembly 500 has two spans, first span 501 and second span 509. Integral bearing assembly 500 may be made of any material that is appropriate for withstanding typical loads, fatigue, wear, and stress, including bearing steel or any other type of steel or steel alloy. First span 501 of integral bearing assembly 500 preferably has a bearing flange 503 that may abut drive flange 490 and fits concentrically around second section 440 of pinion shaft 400 on integral bearing seat 445. Bearing flange 503 allows assembly of integral bearing assembly 500 to an outer housing. In an alternative embodiment, the position of bearing flange 503 may be reversed; thus, bearing flange 503 may be part of second span 509 of integral bearing assembly 500. In the embodiment shown in FIG. 3, first bearing 504 is contained within first span 501 of integral bearing assembly 500 and is preferably a tapered roller bearing. The rolling elements of first bearing 504 roll in outer race 508 and inner race 502. Second span 509 is the portion of integral bearing assembly 500 that is coaxial with third section 450 of pinion shaft 400 and contains second bearing 505. Second bearing 505 is preferably a tapered roller bearing. The rolling elements of second bearing 505 roll in outer race 508, which is shared by first bearing 504; however, the rolling elements 506 of second bearing 505 roll in inner race 455, which is formed (e.g., ground, machined, or forged) into the increasing angle portion of third section 450. The backsides of rolling elements 506 abut small lip 507.

In a preferred embodiment, as shown in FIG. 3, roll-over fastener 480, located in first section 430, provides a higher level of bearing preload control. Rolling the formable end 410 of pinion shaft 400 into counterbore 493 pushes drive flange 490 closer to integral bearing assembly 500, creating preload. Also, because the pinion/bearing manufacture may preferably roll roll-over fastener 480 into counterbore 493, the manufacturer may control the bearing preload, directly affecting the life of the bearings and thus, the efficiency of the pinion assembly.

Pinion shaft 400 preferably can have a greater diameter than other known pinion assembly configurations. Inner race 455 of second bearing 505 in integral bearing assembly 500 is formed (e.g., ground, machined, or forged) directly into a portion of third section 450 of pinion shaft 400. Because there is no need for a separate inner ring, the diameter of pinion shaft 400 may be increased, which will increase pinion stiffness. Also, by increasing the diameter of pinion shaft 400, the entire pinion assembly is stronger and the second end 509 of integral bearing assembly 500 can be moved closer to second end 420 of pinion shaft 400. This increases the stiffness of pinion assembly 400 by optimizing the distance between the pressure point 300 and load line 325, as previously shown in FIG. 2.

Increasing the pinion shaft diameter should increase pinion assembly stiffness exponentially, which prevents deflection and allows more efficient energy (torque) transmission through pinion shaft 400 to the wheels.

Also, the strength of the assembly is preferably increased by having inner race 455 of second bearing 505 in integral bearing assembly 500 formed (e.g., machined, ground, or forged) directly into third section 450 of pinion shaft 400. By having inner race 455 ground into pinion shaft 400, the backsides of rolling elements 506 are supported by small lip 507 of third section 450, increasing the strength of the assembly of pinion shaft 400.

Integral bearing assembly 500 eliminates the need for double machining, which prevents misalignment of bearings 504 and 505 in pinion shaft 400 and removes machining inaccuracies, thus, decreasing manufacture, assembly, and service time. Because integral bearing assembly 500 is one piece, it may be considered a plug-in unit, providing easier and quicker assembly for car or axle manufacturers or service persons. Also, the bearings within integral bearing assembly 500 are closer to the drive gear, reducing vibrations within pinion shaft 400, which decreases bearing noise and increases stiffness, allowing for longer bearing life.

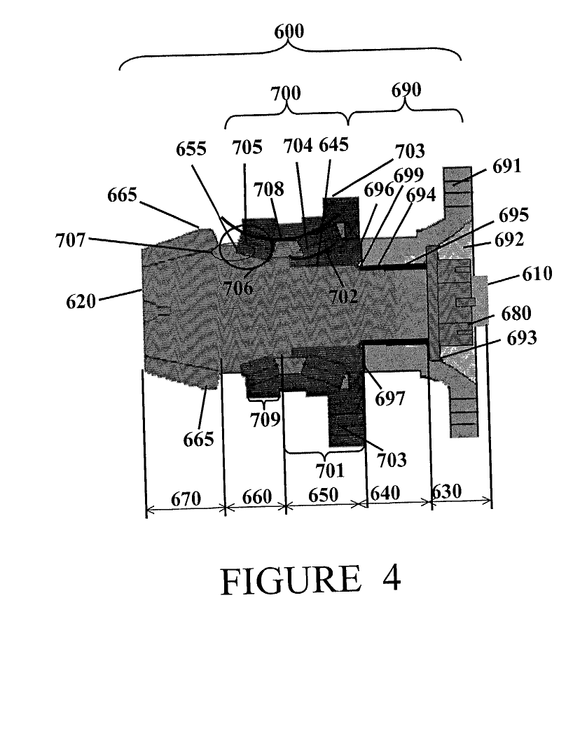

FIG. 4 depicts an alternative embodiment of an integral bearing assembly of the present invention. Pinion shaft 600 has two ends 610 and 620 and five cylindrical sections 630, 640, 650, 660, and 670. Pinion shaft 600 may be made of any material that is appropriate for withstanding typical loads, fatigue, wear, and stress, e.g., steel or steel alloys and other materials with similar or related properties. First end 610 of pinion shaft 600 is the beginning of first section 630. First section 630 is preferably cylindrical, has the smallest diameter, and extends from first end 610 to second section 640.

Second section 640 is preferably substantially or relatively cylindrical or tubular in shape (although it may be of other equivalent shapes as well), extends from first section 630 to third section 650 and preferably has a diameter greater than first section 630 but smaller than third section 650.

Third section 650 is preferably substantially or relatively cylindrical or tubular in shape (although it may be of other equivalent shapes as well), extends from second section 640 to fourth section 660 and preferably has a uniform diameter greater than second section 640 but smaller than fourth section 660. The entire diameter of third section 650 is preferably formed (e.g., ground, machined, or forged) to serve as integral bearing seat 645. Integral bearing seat 645 is where the integral bearing assembly contacts pinion shaft 600 and is located around the circumference of second section 640 of pinion shaft 600.

Fourth section 660 is preferably relatively cylindrical or tubular in shape (although it may be of other equivalent shapes as well), extends from third section 650 to fifth section 670, and preferably has varying diameters, all of which are preferably greater than third section 650 but smaller than fifth section 670. Fourth section 660 preferably has a formed (e.g., machined, ground, or forged) portion increasingly angled toward fifth section 670 that serves as the inner race 655 for the second bearing 705 in an integral bearing assembly 700. Before fourth section 660 abuts fifth section 670, the diameter is increased and there is a small lip 707. After small lip 707, the diameter of pinion shaft 600 remains relatively constant.

Fifth section 670 is preferably shaped like a modified truncated cone and has varying diameters, all of which are greater than the diameter of fourth section 660. Fifth section 670 is preferably angled at an increasing angle away from fourth section 660. The angle is truncated at second end 620 of pinion shaft 600.

First end 610 of pinion shaft 600 is connected to the drive shaft, preferably by a method such as a spline coupling with a retainer ring or bolt and interference fit. A threaded fastener 680 may be placed over the first section 630 to hold pinion shaft 600 in proper positioning within drive flange 690. Threaded fastener 680 may be made of any material that is appropriate for withstanding typical loads, fatigue, wear and stress, such as for example, steel or steel alloys. Drive flange 690 is coaxial with pinion shaft 600 and is held into place by threaded fastener 680 and spline coupling 695.

Drive flange 690 has a two ends 691 and 699, is coaxial with pinion shaft 600, and is held into place by threaded fastener 680. Drive flange 690 may be made of any material that is appropriate for withstanding typical loads, fatigue, wear and stress, such as for example, steel or steel alloys. First end 691 has a large diameter with a concentric concave angled aperture 692. Aperture 692 extends at a decreasing angle towards the interior end of drive flange 690 and includes counterbore 693. Threaded fastener 680 rests in counterbore 693 and is preferably of a larger diameter than the hollow cylindrical section 694 of drive flange 690. Spline coupling 695 of hollow cylindrical section 694 fits concentrically around a portion of first section 630 and may be a typical spline coupling or fitting or any other mechanical equivalent. Hollow cylindrical section 694 of drive flange 690 extends from threaded fastener 680 to second end 699, which may abut integral bearing assembly 700. Hollow cylindrical section 694 fits concentrically around second section 640 of pinion shaft 600. Shims 696 and 697 may be placed between second end 699 of drive flange 690 and first span 701 of integral bearing assembly 700.

Integral bearing assembly 700 has two spans: first span 701 and second span 709. Integral bearing assembly 700 may be made of any material that is appropriate for withstanding typical loads, fatigue, wear, and stress, including bearing steel or any other type of steel or steel alloy. First span 701 preferably has a bearing flange 703 that may abut drive flange 690 and fits concentrically around third section 650 of pinion shaft 600 on integral bearing seat 645. Bearing flange 703 allows assembly of the integral bearing assembly 700 to an outer housing. In an alternative embodiment, the position of bearing flange 703 may be reversed; thus, bearing flange 703 may be part of second span 709 of integral bearing assembly 700. In the embodiment shown in FIG. 4, first bearing 704 is preferably contained within first span 701 of integral bearing assembly 700 and is preferably a tapered roller bearing. The rolling elements 706 of first bearing 704 roll in outer race 708 and inner race 702. Second span 709 is the portion of integral bearing assembly 700 that is coaxial with fourth section 660 of pinion shaft 600 and contains second bearing 705. Second bearing 705 is preferably a tapered roller bearing. The rolling elements of second bearing 705 roll in outer race 708, which is shared by first bearing 704; however, the rolling elements 706 of second bearing 705 roll in inner race 655, which is formed (e.g., ground, machined or forged) into the increasing angle portion of fourth section 660. The backsides of rolling elements 706 abut small lip 707 of fourth section 660 of pinion shaft 600.

In FIG. 4, threaded fastener 680, located in first section 630, contributes to controlling bearing preload. Tightening threaded fastener 680 against counterbore 693 of drive flange 690 pushes drive flange 690 closer to integral assembly 700, creating bearing preload. Stiffness within the pinion assembly prevents vertical and axial movement of pinion shaft 600, which improves torque transmission, efficiency, and reduces noise. A light preload reduces the stiffness of the pinion assembly and creates noise within the bearing, which may reduce the life of the bearing. Conversely, a heavy preload can also cause premature failure of the bearing. Thus, the ability to control bearing preload precisely allows bearing manufacturers to control and predict the life of the bearing.

Drive flange 690 attaches to a drive shaft associated with the engine and interacts with a drive gear to transmit and control the amount of torque through pinion shaft 600 to a differential.

Pinion shaft 600 preferably can have a greater diameter than other known pinion assembly configurations. Inner race 655 of second bearing 705 in integral bearing assembly 700 is ground directly into fourth section 660 of pinion shaft 600. Because there is no need for a separate inner ring, the diameter of pinion shaft 600 may be increased, which will increase the stiffness of pinion 600. Also, by having inner race 655 of second bearing 705 in integral bearing assembly 700 formed (e.g., ground, machined, or forged) directly into fourth section 660 of pinion shaft 600, the diameter of pinion shaft 600 may be greater than when inner race 655 is not formed in pinion shaft 600. A greater pinion diameter increases the strength and stiffness of the pinion assembly. Additionally, the distance between the pressure point 300 and load line 325 (as shown in FIG. 2) can be optimized. By forming inner race 655 into a portion of fourth section 660 of pinion shaft 600, the backsides of rolling elements 706 are supported by small lip 707 of truncated cone-shaped fourth section 660, meaning that the inner race may be formed into pinion shaft 600 closer to the second end 620 of pinion shaft 600. Moving inner race 655 along pinion shaft 600 closer to second end 620 of pinion shaft 600 also moves rolling elements 706 closer to second end 620 of pinion shaft 600 and consequently shifts the pressure point 300 closer to the load line 325 (as shown in FIG. 2), which also increases stiffness of the pinion assembly.

Integral bearing assembly 700 eliminates the need for double machining, which removes machining inaccuracies and prevents misalignment of bearings 704 and 705 in pinion shaft 600. Because integral bearing 700 is one piece, it is considered a plug-in unit, providing easier and quicker assembly for car or axle manufacturers. Also, the bearings within integral bearing assembly 700 are closer to the drive gear, reducing vibrations within pinion shaft 600, which decreases bearing noise and allows for longer bearing life.

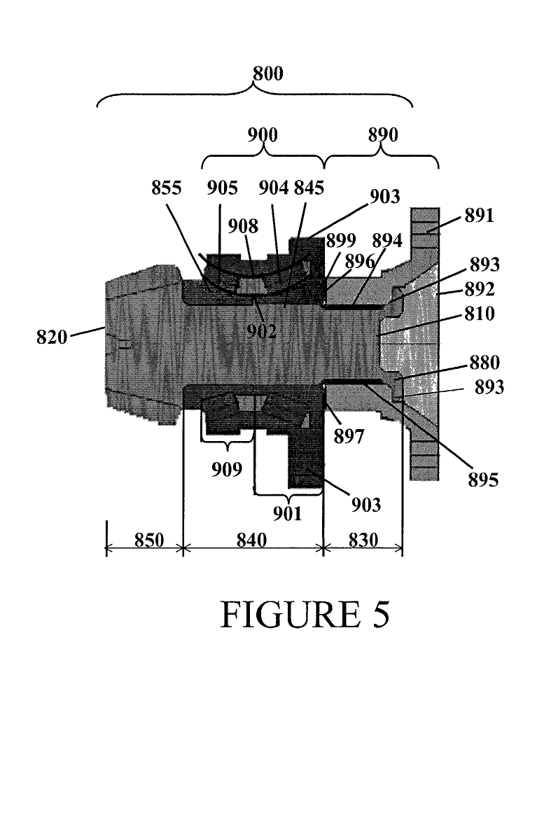

FIG. 5 is another embodiment of the present invention that utilizes a integral bearing assembly and a roll-over fastener. Pinion shaft 800 preferably has two ends 810 and 820 and three substantially cylindrical or tubular (or equivalent shapes) sections 830, 840, and 850. Pinion shaft 800 may be made of any material that is appropriate for withstanding typical loads, fatigue, wear, and stress, such as for example, steel or steel alloys and other materials with similar or related properties.

First end 810 of pinion shaft 800 is preferably of a formable material such that the material may be rolled over an adjoining component for fastening purposes. First section 830 includes first end 810, is preferably substantially or relatively cylindrical or tubular in shape with the exception of the portion of pinion shaft 800 that forms roll-over fastener 880 (although it may be of other equivalent shapes as well), has the smallest diameter of the sections, and extends from first end 810 to second section 840.

Second section 840 is preferably substantially or relatively cylindrical or tubular in shape (although it may be of other equivalent shapes as well), extends from first section 830 to third section 850, and has a diameter greater than first section 830 but smaller than third section 850. The entire diameter of second section 840 may be formed to serve as a integral bearing seat 845. Integral bearing seat 845 is where integral bearing assembly 900 contacts pinion shaft 800 and is located around the circumference of second section 840 of pinion shaft 800.

Third section 850 is preferably shaped like a modified truncated cone and has varying diameters, all of which are greater than the diameter of second section 840. Where third section 850 abuts second section 840 the diameter is increased. Next, third section 850 is angled at any increasing angle away from second section 840 of pinion shaft 800. The angle is truncated at second end 820 of pinion shaft 800.

First end 810 of pinion shaft 800 is preferably made of formable material that is adapted to be rolled over counterbore 893 in drive flange 890 to serve as a roll-over fastener 880 which holds pinion shaft 800 in proper positioning within drive flange 890. Drive flange 890 is coaxial with the pinion shaft and is held in place by roll-over fastener 880.

Drive flange 890 has two ends 891 and 899, is coaxial with the pinion shaft and is preferably held in place by roll-over fastener 880 and a spline coupling 895. Drive flange 890 may be made of any material that is appropriate for withstanding typical loads, fatigue, wear and stress, such as for example, steel or steel alloys. First end 891 has a concentric concave angled aperture 892. Aperture 892 may extend at a decreasing angle towards interior end 899 and includes counterbore 893. Counterbore 893 is inside interior end 899 of drive flange 890. Counterbore 893 is what roll-over fastener 880 curves into once it is rolled and is preferably of a larger diameter than the hollow cylindrical section 894 of drive flange 890. Spline coupling 895 of hollow cylindrical section 894 fits concentrically around a portion of first section 830 and may be a typical spline coupling or fitting or any other mechanical equivalent. Hollow cylindrical section 894 extends from roll-over fastener 880 to second end 899 of drive flange 890, which may abut integral bearing assembly 900. Shims 896 and 897 may be placed between second end 899 of drive flange 890 and first span 901 of integral bearing assembly 900.

Integral bearing assembly 900 has two spans, first span 901 and second span 909. Integral bearing assembly 900 may be made of any material that is appropriate for withstanding typical loads, fatigue, wear, and stress, including bearing steel or any other type of steel or steel alloy. First span 901 of integral bearing assembly 900 preferably has a bearing flange 903 that may abut drive flange 890 and fits concentrically around second section 840 of pinion shaft 800 on integral bearing seat 845. Bearing flange 903 allows assembly of the integral bearing assembly 900 to an outer housing. In an alternative embodiment, the position of bearing flange 903 may be reversed; thus, bearing flange 903 may be part of second span 909. In the embodiment shown in FIG. 5, first bearing 904 is contained within first span 901 of integral bearing assembly 900 and is preferably a tapered roller bearing. The rolling elements of first bearing 904 roll in outer race 908 and inner race 902. Second span 909 contains second bearing 905, which is preferably a tapered roller bearing. The rolling elements of second bearing 905 also roll in outer race 908 and inner race 902.

In a preferred embodiment, as shown in FIG. 5, roll-over fastener 880, located in first section 830, provides a higher level of bearing preload control. Rolling the formable end 810 of pinion shaft 800 into counterbore 893 pushes drive flange 890 closer to integral bearing assembly 900, creating preload. Also, because the pinion/bearing manufacture may preferably roll roll-over fastener 880 into counterbore 893, the manufacturer may control the bearing preload, directly affecting the life of the bearings and thus, the efficiency of the pinion assembly.

Integral bearing assembly 900 eliminates the need for double machining, which prevents misalignment of bearings 904 and 905 in pinion shaft 800 and removes machining inaccuracies, thus, decreasing manufacture, assembly, and service time. Because integral bearing 900 is one piece, it may be considered a plug-in unit, providing easier and quicker assembly for car or axle manufacturers or service persons.

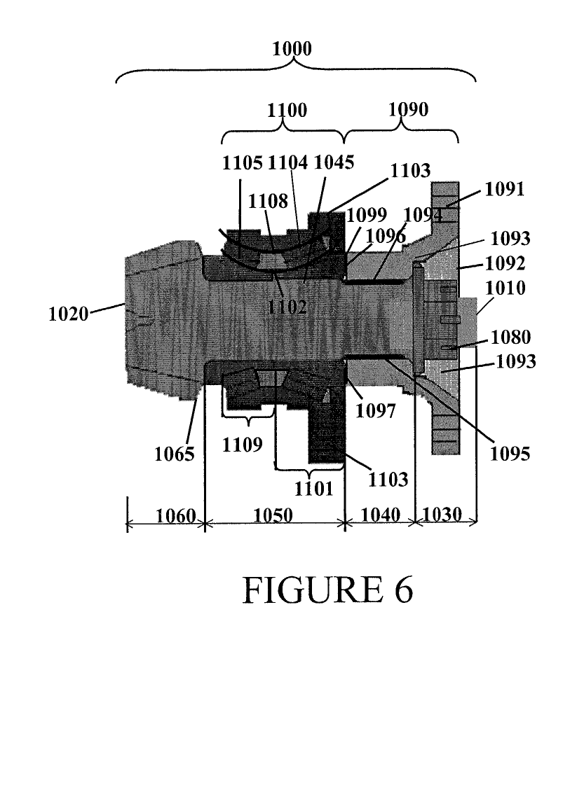

FIG. 6 depicts an alternative embodiment of an integral bearing assembly of the present invention. Pinion shaft 1000 has two ends 1010 and 1020 and four cylindrical sections 1030, 1040, 1050, and 1060. Pinion shaft 1000 may be made of any material that is appropriate for withstanding typical loads, fatigue, wear, and stress, e.g., steel or steel alloys and other materials with similar or related properties. First end 1010 of pinion shaft 1000 is the beginning of first section 1030. First section 1030 is cylindrical, preferably has the smallest diameter, is threaded, and extends from first end 1010 to second section 1040.

Second section 1040 is preferably substantially or relatively cylindrical or tubular in shape (although it may be of other equivalent shapes as well), extends from first section 1030 to third section 1050 and preferably has a diameter greater than first section 1030 but smaller than third section 1050.

Third section 1050 is preferably substantially or relatively cylindrical or tubular in shape (although it may be of other equivalent shapes as well), extends from second section 1040 to fourth section 1060 and has a uniform diameter that may be greater than second section 1040 but smaller than fourth section 1060. The entire diameter of third section 1050 is preferably formed (e.g., ground, machined, or forged) to serve as integral bearing seat 1045. Integral bearing seat 1045 is where the integral bearing assembly contacts pinion shaft 1000 and is located around the circumference of second section 1040 of pinion shaft 1000.

Fourth section 1060 is preferably shaped like a modified truncated cone and has varying diameters, all of which are preferably greater than the diameter of third section 1050. Where fourth section 1060 abuts third section 1050 the diameter is increased. Next, fourth section 1060 is angled at any increasing angle away from third section 1050 of pinion shaft 1000. The angle is truncated at second end 1020 of pinion shaft 1000.

First end 1010 of pinion shaft 1000 is connected to the drive shaft, preferably by a method such as a spline coupling with a retainer ring or bolt and interference fit. A threaded fastener 1080 may be placed over the first section 1030 to hold pinion shaft 1000 in proper positioning within drive flange 1090. Threaded fastener 1080 may be made of any material that is appropriate for withstanding typical loads, fatigue, wear and stress, such as for example, steel or steel alloys. Drive flange 1090 is coaxial with pinion shaft 1000 and is held into place by threaded fastener 1080 and spline coupling 1095.

Drive flange 1090 has a two ends 1091 and 1099, is coaxial with pinion shaft 1000, and is held into place by threaded fastener 1080. Drive flange 1090 may be made of any material that is appropriate for withstanding typical loads, fatigue, wear and stress, such as for example, steel or steel alloys. First end 1091 of drive flange 1090 has a large diameter with a concentric concave angled aperture 1092. Aperture 1092 extends at a decreasing angle towards the interior end of drive flange 1090 and includes counterbore 1093. Counterbore 1093 is what threaded fastener 1080 rests in and is preferably of a larger diameter than the hollow cylindrical section 1094 of drive flange 1090. Spline coupling 1095 of hollow cylindrical section 1094 fits concentrically around a portion of first section 1030 and may be a typical spline coupling or fitting or any other mechanical equivalent. Hollow cylindrical section 1094 of drive flange 1090 extends from threaded fastener 1080 to second end 1099, which may abut integral bearing assembly 1100. Hollow cylindrical section 1094 fits concentrically around second section 1040 of pinion shaft 1000. Shims 1096 and 1097 may be placed between second end 1099 of drive flange 1090 and first span 1101 of integral bearing assembly 1000.

Integral bearing assembly 1100 has two spans, first span 1101 and second span 1109. Integral bearing assembly 1100 may be made of any material that is appropriate for withstanding typical loads, fatigue, wear, and stress, including bearing steel or any other type of steel or steel alloy. First span 1101 of integral bearing assembly 1100 preferably has a bearing flange 1103 that may abut drive flange 1090 and fits concentrically around third section 1050 of pinion shaft 1000 on integral bearing seat 1045. Bearing flange 1103 allows assembly of the integral bearing assembly 1100 to an outer housing. In an alternative embodiment, the position of bearing flange 1103 may be reversed; thus, bearing flange 1103 may be part of second span 1109. In the embodiment shown in FIG. 6, first bearing 1104 is contained within first span 1101 of integral bearing assembly 1100 and is preferably a tapered roller bearing. The rolling elements of first bearing 1104 roll in outer race 1108 and inner race 1102. Second span 1109 contains second bearing 1105, which is preferably a tapered roller bearing. The rolling elements of second bearing 1105 also roll in outer race 1108 and inner race 1102.

In FIG. 6, threaded fastener 1080, located in first section 1030, contributes to controlling bearing preload. Tightening threaded fastener 1080 against counterbore 1093 of drive flange 1090 pushes drive flange 1090 closer to integral assembly 1100, creating bearing preload. Stiffness within the pinion assembly reduces vertical and axial movement of pinion shaft 1000, which improves torque transmission, efficiency, and reduces noise. A light preload reduces the stiffness of the pinion assembly and creates noise within the bearing, which may reduce the life of the bearing. Conversely, a heavy preload can also cause premature failure of the bearing. Thus, the ability to control bearing preload precisely allows bearing manufacturers to control and predict the life of the bearing.

Drive flange 1090 attaches to a drive shaft associated with the engine and interacts with a drive gear to transmit and control the amount of torque through pinion shaft 1000 to a differential.

Integral bearing assembly 1100 eliminates the need for double machining, which removes machining inaccuracies and prevents misalignment of bearings 1104 and 1105 in pinion shaft 1000. Because integral bearing 1100 is one-piece, it is considered a plug-in unit, providing easier and quicker assembly for car or axle manufacturers. Also, the bearings within integral bearing assembly 1100 are closer to the drive gear, reducing vibrations within pinion shaft 1000, which decreases bearing noise, allowing for longer bearing life.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims:

I claim:

1. A pinion assembly comprising:
a pinion shaft having varying diameters and having a first and second end, wherein said first end is adapted to fasten to a drive flange;
a roll-over fastener formed on said first end of said pinion shaft;
a drive flange that is connected to said first end of said pinion shaft by said pinion shaft fastener;
an integral bearing assembly comprising a first and second end rotatably connected to said pinion shaft wherein said integral bearing assembly comprises a plurality of rolling element bearings, each bearing having an inner and outer race.

2. The assembly of claim 1, wherein said first end of said pinion shaft abuts said drive flange.

3. The assembly of claim 1, wherein said integral bearing assembly comprises two rolling element bearings.

4. A pinion assembly comprising:
a pinion shaft having varying diameters and having a first and second end, wherein said first end is adapted for a connection to a threaded fastener;
a drive flange that is connected to said first end of said pinion shaft by a threaded fastener; and wherein said fastener fastens said pinion shaft to said drive flange; and
an integral bearing assembly comprising a first and second end rotatably connected to said pinion shaft wherein said integral bearing assembly comprises a plurality of rolling element bearings, each bearing having an inner and outer race, wherein said inner race of said rolling element bearing is formed into said second end of said pinion shaft.

5. The assembly of claim 4, wherein said first end of said pinion shaft abuts said drive flange.

6. The assembly of claim 4, wherein said integral bearing assembly comprises two rolling element bearings.

7. A method for controlling bearing preload in a pinion assembly, wherein said pinion assembly comprises a roll-over fastener, wherein said fastener fastens said pinion assembly to a drive flange; a pinion shaft having a first and second end, wherein said first end is adapted to be rolled over to attach said drive flange; and an integral bearing assembly rotatably connected to said pinion shaft wherein said integral bearing assembly comprises a plurality of rolling element bearings, each with an inner and outer race; comprising the steps of:
positioning an inner race on said pinion shaft; and
adjusting said fastener to control said preload;
wherein said adjusting step forces said drive flange closer to said bearing assembly.

8. The assembly of claim 7, wherein said integral bearing assembly comprises two rolling element bearings.

9. The method of claim 7, wherein inner race of second bearing race is ground into said second end of said pinion shaft.

10. A method for increasing stiffness in a pinion assembly, wherein said pinion assembly comprises a fastener, wherein said fastener fastens said pinion assembly to a drive flange; a pinion shaft having a first and second end, wherein said first end is located in close proximity to said fastener; an integral bearing assembly rotatably connected to said pinion shaft wherein said integral bearing assembly comprises a plurality of rolling element bearings, each with an inner and outer race, comprising the steps of:
providing a pinion shaft comprising an inner race, wherein diameter of said pinion shaft may be increased;
positioning said rolling element bearings on said pinion shaft, wherein diameter of said pinion shaft may be increased; and
optimizing the distance between a pressure point and load lines, wherein forces along said pinion shaft are redistributed.

11. The method of claim 10, wherein said fastener comprises a threaded fastener.

12. The method of claim 10, wherein said fastener comprises a roll-over fastener.

13. The method of claim 10, wherein said positioning step comprises positioning said rolling element bearings closer to a pinion gear.

14. A method for decreasing the assembly time of a pinion assembly, wherein said pinion assembly comprises a fastener, wherein said fastener fastens said pinion assembly to a drive flange; a pinion shaft having a first and second end wherein said first end is connected or adapted to said fastener; an integral bearing assembly rotatably connected to said pinion shaft wherein said integral bearing assembly comprises a plurality of rolling element bearings, each with an inner and outer race, comprising the steps of:
controlling bearing flange to pinion gear distance; and
integrating said plurality of rolling element bearings, wherein said integrated bearing may be assembled as one component.

15. The method of claim 14, wherein said fastener is a threaded fastener.

16. The method of claim 14, wherein said fastener is a roll-over fastener.

17. A method for decreasing the manufacture time of a pinion assembly wherein said pinion assembly comprises a fastener, wherein said fastener fastens said pinion assembly to a drive flange; a pinion shaft having a first and second end wherein said first end is connected or adapted to said fastener; an integral bearing assembly comprising a first and second end rotatably connected to said pinion shaft, comprising the step of:
minimizing the number of areas to be formed on said pinion in a manufacturing operation.

18. The method of claim 17, wherein said minimizing step further comprises grinding one bearing seat.

19. The method of claim 17, wherein said fastener further comprises a threaded fastener.

20. The method of claim 17, wherein said fastener further comprises a roll-over fastener.
